(19) United States
(12) Patent Application Publication
(10) Pub. No.: US 2022/0248066 A1
(43) Pub. Date: Aug. 4, 2022

(54) Live Broadcast Interaction Method, Apparatus, Device and Storage Medium

(71) Applicant: Alibaba Group Holding Limited, Grand Cayman (KY)

(72) Inventors: Shibo Liu, Hangzhou (CN); Jiandong Ding, Hangzhou (CN); Yongji He, Hangzhou (CN)

(21) Appl. No.: 17/585,374

(22) Filed: Jan. 26, 2022

(30) Foreign Application Priority Data
Feb. 2, 2021 (CN) 202110144228.8

(51) Int. Cl. H04N 21/2187; H04N 21/222

(52) U.S. Cl. CPC H04N 21/2187; H04N 21/222

(57) ABSTRACT

Live broadcast interaction method, apparatus, device, and storage medium are provided. The method is applied in a live broadcast cooperative server connected to multiple live broadcast ends and multiple live broadcast service providers, and includes: receiving a live broadcast request sent by a first live broadcast end; providing a list of one or more connectable second live broadcast ends to the first live broadcast end; receiving a confirmation result from the first live broadcast end or a second live broadcast end; receiving original live broadcast data of the first live broadcast end and at least one second live broadcast end according to the confirmation result; processing the original live broadcast data to generate final live broadcast data; and sending the final live broadcast data to one or more live broadcast service providers. A connection across live broadcast service providers can be realized, and the scalability of live broadcast is improved.

### CROSS REFERENCE TO RELATED PATENT APPLICATIONS

This application claims priority to Chinese Patent Application No. 202110144228.8, filed on 2 Feb. 2021 and entitled “Live Broadcast Interaction Method, Apparatus, Device and Storage Medium,” which is hereby incorporated by reference in its entirety.

### TECHNICAL FIELD

The present disclosure relates to the field of data processing technology, and in particular, to live broadcast interaction methods and apparatuses, and electronic devices and storage media.

### BACKGROUND

With the continuous development of Internet technology, web live broadcasting has gradually emerged, including various forms of live broadcasting, such as game live broadcasts, e-commerce live broadcasts, talent live broadcasts, and other forms of live broadcasts.

An broadcaster may register an account on each live broadcast platform for live broadcast, and live broadcasts on different platforms need to log in with different accounts. Sometimes a broadcaster may connect to another broadcaster during a live broadcast, i.e., live broadcasts of two broadcasters are connected together for doing live broadcast. This type of collaborative live broadcast usually requires two broadcasters to be on the same platform, and broadcasters on different platforms cannot be linked.

At present, due to limitations of platforms, live broadcast may only be connected between broadcasters on the same platform, incurring limitations to live broadcast.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer readable instructions as permitted by the context above and throughout the present disclosure.

Embodiments of the present disclosure provide a live broadcast interaction method to improve the scalability of live broadcast.

Correspondingly, the embodiments of the present disclosure also provide a data processing apparatus, an electronic device, and a storage medium to ensure implementations and applications of the above method.

In order to solve above problems, embodiments of the present disclosure disclose a live broadcast interaction method, which may be applied to a live broadcast collaborative server capable to connect to multiple live broadcast ends. The live broadcast collaborative server may connect to multiple live broadcast service providers. The method includes: receiving a live broadcast request sent by a first live broadcast end; providing a list of one or more connectable second live broadcast ends to the first live broadcast end; receiving a confirmation result from the first live broadcast end or a second live broadcast end; receiving original live broadcast data of the first live broadcast end and at least one second live broadcast end according to the confirmation result; processing the original live broadcast data to generate final live broadcast data; and sending the final live broadcast data to one or more live broadcast service providers.

Embodiments of the application also disclose a live broadcast interaction method, for use to enable a first live broadcast end to simultaneously perform live broadcast on multiple live broadcast service providers through a live broadcast collaborative server. The live broadcast interaction method includes: providing a live broadcast interactive interface, the interactive interface including platform settings and connection settings; receiving platform setting information and connection setting information corresponding to a live broadcast user; sending the platform setting information and the connection setting information to the live broadcast collaborative server; receiving connection confirmation information from the live broadcast collaborative server; obtaining first original live broadcast data and providing the first original live broadcast data to the live broadcast collaborative server; receiving final live broadcast data from the live broadcast collaborative server, wherein the platform settings include multiple selectable live service providers, the connection settings include multiple selectable second live broadcast ends, and the final live broadcast data includes at least a portion of the first original live broadcast data.

Embodiments of the application also disclose a live broadcast interaction method, for use to enable a first live broadcast end to simultaneously perform live broadcast on multiple live broadcast service providers through a live broadcast collaborative server. The first live broadcast end may utilize a shared live broadcast device. The method includes: logging into a live broadcast account of a live broadcast user; providing a live broadcast interactive interface, the live broadcast interactive interface including platform settings and connection settings; receiving live broadcast selection information corresponding to the live broadcast user; sending the live broadcast selection information to a live broadcast collaborative server; receiving connection confirmation information from the live broadcast collaborative server to determine a connection result with at least one second live broadcast end; obtaining first original live broadcast data and providing the first original live broadcast data to the live broadcast collaborative server; receiving final live broadcast data from the live broadcast collaborative server, the final live broadcast data including at least a portion of the first original live broadcast data; and sending a withdrawal request to the live broadcast collaborative server.

Embodiments of the application also disclose a live broadcast interaction method, which may be applied to a live broadcast collaborative server connecting to multiple live broadcast ends, and the live broadcast collaborative server may also connect to multiple live broadcast service providers. The method includes: receiving connection setting information of a first live broadcast end; querying for one or more second live broadcast ends according to the connection setting information; providing a list of one or more second live broadcast ends that are connectable to the first live broadcast end; receiving a connection initiation request from the first live broadcast end, the connection initiation request being generated according to second live broadcast end(s) selected from the list; receiving connection confirmation result(s) of the second live broadcast end(s); establishing a connection relationship between the first live broadcast end and at least one second live broadcast end according to the connection confirmation result(s); receiving first original live broadcast data of the first live broadcast end and second original live broadcast data of the second live broadcast end; combining the first original live broadcast data and at least one second original live broadcast data to obtain final live broadcast data according to the connection relationship; and sending the final live broadcast data to live broadcast service provider(s).

Embodiments of the present disclosure also disclose a live broadcast interactive system, which may be implemented in an electronic device of a live broadcast user, so that the live broadcast user may perform live broadcast simultaneously on multiple live broadcast service providers through a live broadcast collaborative server. The system includes: a live broadcast interface unit, a video acquisition unit and a communication unit. The live broadcast interface unit is configured to provide live broadcast setting options and receive settings inputted from the live broadcast user, and includes: a platform setting interface that provides multiple selectable live broadcast service platforms, a connection setting interface that provides other selectable live broadcast users, and a video setting interface that provides selectable video setting parameters. The video acquisition unit is configured to shoot video, and the communication unit is configured to transmit setting information and live broadcast data to the live broadcast collaborative server.

Embodiments of the present disclosure also disclose an electronic device, which includes: a processor, and a memory with executable codes stored thereon. When executed, the executable codes cause the processor to execute one or more of the methods described in the embodiments of the present disclosure.

Embodiments of the present disclosure also disclose one or more machine-readable media with executable codes stored thereon. When executed, the executable codes cause a processor to execute one or more of the methods described in the embodiments of the present disclosure.

Compared with existing technologies, the embodiments of the present disclosure include the following advantages:

In embodiments of the present disclosure, a live broadcast collaborative server of a live broadcast system is connected to servers of multiple live broadcast service providers to realize interactions between the live broadcast service providers. As such, a first live broadcast end may initiate a connection, and establishes a live broadcast end group with second live broadcast end(s) that confirm(s) the connection. A selection option of the live broadcast end is not limited to those of the same live broadcast service provider. After that, live broadcast data of live broadcast ends in the live broadcast end group may be combined, and final live broadcast data is fed back to live broadcast devices. And associated stream is also pushed to servers of respective live broadcast service providers to which the live broadcast ends belong, thus realizing connections across multiple live broadcast service providers and improve the scalability of live broadcast.

### BRIEF DESCRIPTION OF THE DRAWINGS

FIG. 1 is a schematic structural diagram of a live broadcast system according to embodiments of the present disclosure.

FIG. 2 is a flowchart of an exemplary live broadcast interaction method of the present disclosure.

FIGS. 3A and 3B are schematic diagrams of an example of connection screen combination according to embodiments of the present disclosure.

FIG. 4 is a flowchart of another exemplary live broadcast interaction method of the present disclosure.

FIG. 5 is a schematic diagram of an example of a live broadcast interaction according to embodiments of the present disclosure.

FIG. 6 is a flowchart of an exemplary live broadcast interaction method of the present disclosure.

FIG. 7 is a flowchart of another exemplary live broadcast interaction method of the present disclosure.

FIG. 8 is a flowchart another exemplary live broadcast interaction method of the present disclosure.

FIG. 9 is a structural block diagram of an exemplary live broadcast interaction apparatus of the present disclosure.

FIG. 10 is a structural block diagram of another exemplary live broadcast interaction apparatus of the present disclosure.

FIG. 11 is a schematic structural diagram of an apparatus provided by an embodiment of the present disclosure.

### DETAILED DESCRIPTION

In order to make the above objectives, features, and advantages of the present disclosure more apparent and understandable, the present disclosure will be further described in detail below with reference to accompanying drawings and specific implementations.

Embodiments of the present disclosure may be applied to the field of live broadcasting, and live broadcasting refers to a broadcasting mode in which post-processing and broadcasting of programs are performed at the same time. The live broadcast of the present disclosure may be web-based live broadcast, and live broadcast video is transmitted through an internet network.

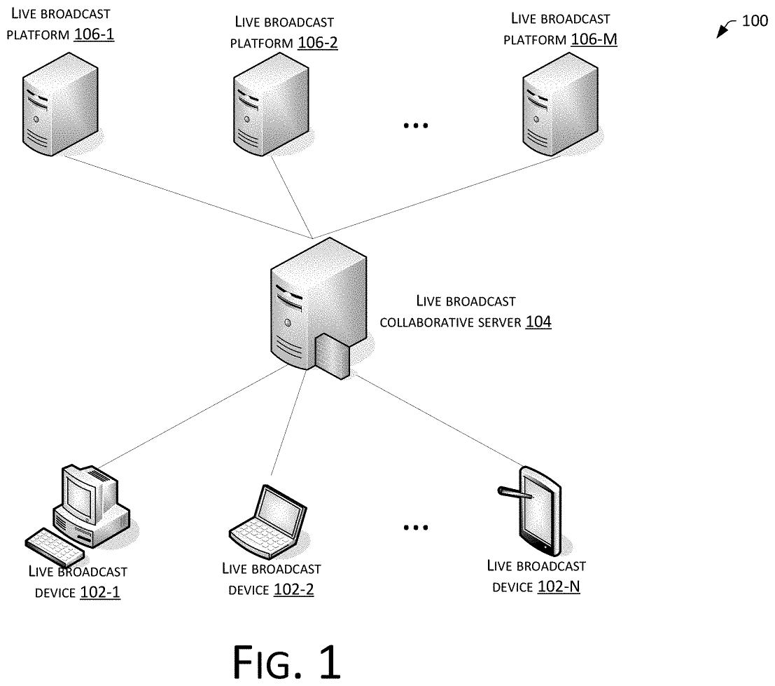

Embodiments of the application may provide a live broadcast system, which includes a live broadcast cooperative server and multiple live broadcast ends. Device(s) of a live broadcast end may be a shared live broadcast device and/or a dedicated live broadcast device. A dedicated live broadcast device refers to a live broadcast device owned by a live broadcast user. A shared live broadcast device refers to a live broadcast device shared by multiple live broadcast users. The live broadcast collaborative server may connect to server devices of multiple live broadcast service providers, thereby being able to connect a live broadcast end with live broadcast service providers, and provide live broadcast data corresponding to the live broadcast end to devices of the live broadcast service providers. A live broadcast service provider may be understood as a live broadcast platform, and the live broadcast collaborative server may thereby provide live broadcast services to various live broadcast platforms. A structure diagram of a live broadcast system 100 is shown in FIG. 1:

Live broadcast ends 102-1, 102-2, . . . , 102-N connect to a live broadcast collaborative server 104, and the live broadcast collaborative server may connect to multiple live broadcast platforms (i.e., live broadcast service providers), such as live broadcast platforms 106-1, 106-2, . . . , 106-M, wherein N and M are positive integers. Therefore, live broadcast devices of these live broadcast ends may connect to various live broadcast platforms through the live broadcast collaborative server, and perform live broadcasts through the live broadcast platforms. The above-mentioned devices include shared live broadcast devices. A shared live broadcast device may be understood as a time-sharing leased live broadcast device. A live broadcast user may rent a shared live broadcast device and log into his/her live broadcast account on a live broadcast website through the shared live broadcast device, so that the live broadcast collaborative server may connect to a corresponding live broadcast platform to provide live broadcast services for the live broadcast user. In this mode, a live broadcast user may log into live broadcast accounts of multiple live broadcast platforms through a set of shared live broadcast devices in a live broadcast room to perform live broadcasts, thus saving device resources. A live broadcast device, such as a shared live broadcast device in a live broadcast room, may include: video acquisition device, audio acquisition device, lighting device, host device, and network device. For example, a video capture device such as camera may be used to capture live video images. An audio capture device such as combination of microphone and sound card may be used to capture voice information of a broadcaster during live broadcast and other audio information such as soundtracks and sound effects. A lighting device such as fill lights may be used to adjust the lighting effect during live broadcast. A live broadcast host machine is used to run various types of live broadcast software, and receive audio and video streams from peripherals and push them to the live broadcast collaborative server. A network device is used to provide a high-speed and stable network to connect to the live broadcast device in the live broadcast room and the live broadcast collaborative server. In other scenarios, the live broadcast user may also use his/her own live broadcast device to connect to the live broadcast collaborative server, and perform live broadcasts on one or more live broadcast platforms through the live broadcast collaborative server. In other scenarios, under authorizations of the live broadcast service provider and the live broadcast end, the server of the live broadcast service provider may also connect to the live broadcast end (not shown in FIG. 1), and establish communications with servers of other live broadcast service providers through the live broadcast collaborative server, to realize live broadcast of the live broadcast end across live broadcast platforms.

Under the above architecture, the live broadcast collaborative server may connect to servers of multiple live broadcast platforms, so that a live broadcast end that is connected to the live broadcast collaborative server may log into accounts of various live broadcast platforms for performing live broadcast. A single set of devices logging into multiple platforms for performing live broadcast may also be supported, thus improving the efficiency of live broadcast. Correspondingly, through above-mentioned architecture, the live broadcast collaborative server may also realize inter-communications between different live broadcast platforms, so that connections between broadcasters of different live broadcast platforms may be realized.

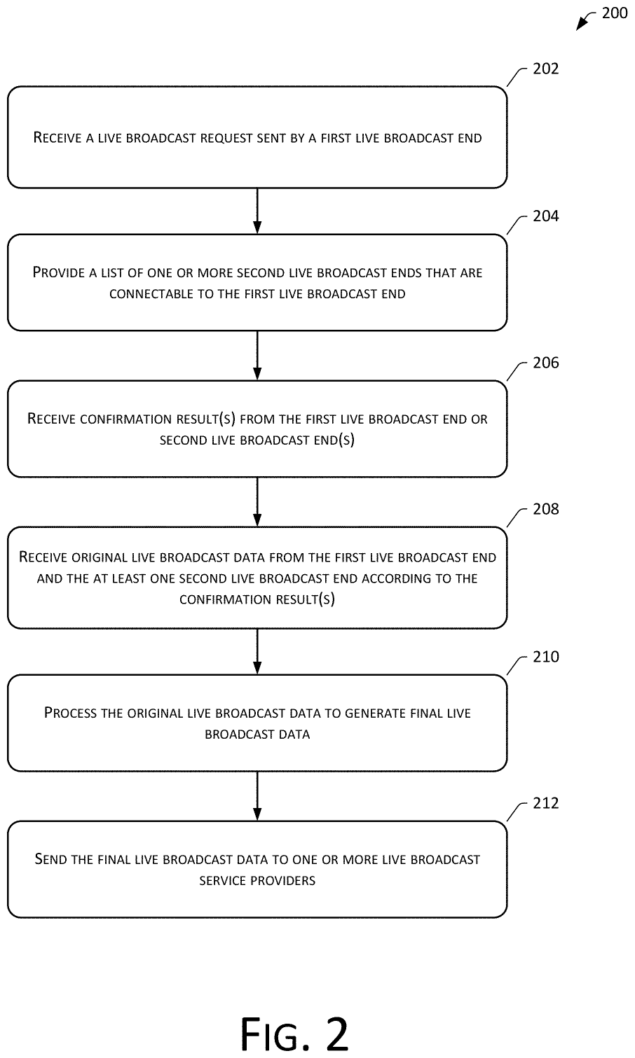

Referring to FIG. 2, a flowchart of an exemplary live broadcast interaction method 200 of the present disclosure is shown.

Step 202: Receive a live broadcast request sent by a first live broadcast end.

The live broadcast collaborative server may receive a live broadcast request sent by a first live broadcast end, and the live broadcast request includes various types of requests required to perform a live broadcast. For example, the live broadcast request includes: a live broadcast start request for starting the live broadcast, and a live broadcast connection request for connecting to other live broadcast ends, etc.

Based on the live broadcast request, corresponding live broadcast information, such as identity information of the live broadcast user, connection requirements, etc., may be obtained. The identity information includes login information and other identity information, such as membership information, level information, etc. The connection requirements include connection filtering requirements, such as provider requirements for live broadcast service providers, and live broadcast requirements for live broadcast ends.

For example, a connected live broadcast platform to connect, i.e., a live broadcast service provider, may be used as the provider requirement. A live broadcast end to connect, such as name of a broadcaster, live broadcast room identification of a broadcaster, etc., may also be specified. Some requirements may also be set to filter some live broadcast ends. As such, live broadcast end(s) for selection of making connection may be in a relatively large scope. For example, by setting requirements, such as type of live broadcast, etc., live broadcast end(s) that is/are selectable may be received from the server. Among these selectable live broadcast ends, certain live broadcast end(s) may be selected to apply for connection.

In embodiments of the present disclosure, identity information of a first live broadcast end is confirmed. Second live broadcast end(s) and/or live broadcast service provider(s) is/are queried according to the identity information. Live broadcast selection information is generated according to the second live broadcast end(s) and/or the live broadcast service provider(s) found. The live broadcast selection information is provided to the first live broadcast end. The live broadcast selection information includes selectable second live broadcast end(s) and live broadcast service provider(s). The identity information of the first live broadcast end may include user name of the live broadcast end, level information, and other identity information that may describe its identity. The live broadcast cooperative server may provide the live broadcast selection information to the first live broadcast end based on the identity information. The live broadcast selection information is used for performing selection(s) for live broadcast, for example, selecting a live broadcast service provider when starting live broadcast, and selecting a second live broadcast end when in need of making connection, etc. Therefore, the live broadcast selection information includes selectable second live broadcast end(s) and live broadcast service provider(s). In embodiments of the present disclosure, the live broadcast selection information may be fed back when the first live broadcast end logging in, or may be fed back based on his/her request, which may be specifically determined according to needs. For example, the live broadcast selection information is fed back when logging in, to facilitate and enable the live broadcast user to select a live broadcast service provider, and also select one or more second live broadcast ends that he/she wants to connect to. In other scenarios, the live broadcast selection information may be provided to the first live broadcast end as a list of one or more second live broadcast ends that can connect, so as to facilitate selection of a second live broadcast end for connection.

Step 204: Provide a list of one or more second live broadcast ends that are connectable to the first live broadcast end.

When the first live broadcast end needs to connect to other live broadcast end(s), the live broadcast collaborative server may provide a list of connectable live broadcast ends, and the list of connectable live broadcast ends includes one or more second live broadcast ends that are able to connect to. The first live broadcast end may select one or more second live broadcast ends from the list to make connection. The first live broadcast end may include connection requirements in the live broadcast request, and the live broadcast cooperative server may also set some connection requirements by default. The first live broadcast end may be understood as the live broadcast end that initiates the connection, and the second live broadcast end may be understood as a live broadcast end other than the first live broadcast end, which may receive connections from other live broadcast ends.

Based on different connection requirements, precise matching or intelligent matching may be performed for connection(s). For example, if the connection requirement includes a designated second live broadcast end, the corresponding second live broadcast end may be accurately matched. For another example, if the connection requirements are related to requirements for live broadcast service provider and second live broadcast end, matching may be performed based on these connection requirements to determine a second live broadcast end that meets such requirements. For example, matching may be performed based on broadcaster type, identity information, etc., or recommendation may be made based on historical connection data of the first live broadcast end, etc.

Based on the connection requirements, one or more second live broadcast ends may be selected to form a corresponding list of selectable live broadcast ends, which may then be sent to the first live broadcast end.

Step 206: Receive confirmation result(s) from the first live broadcast end or second live broadcast end(s).

The first live broadcast end may select one or more second live broadcast ends to be connected based on the list, and then may return the confirmation result of selection to the live broadcast collaborative server. The live broadcast collaborative server may determine one or more second live broadcast ends to which the first live broadcast end wants to connect based on the confirmation result, and respectively send a connection request to the one or more second live broadcast ends to which the first live broadcast end wants to connect. A second live broadcast end thereof may confirm whether to connect and send a corresponding confirmation result to the live broadcast collaborative server. A server of the live broadcast system may determine the first live broadcast end and second live broadcast end(s) that are to be connected based on confirmation result(s).

A connection selection result may be received from the first live broadcast end. The connection selection result includes one or more designated second live broadcast ends. A connection request is sent to the designated second live broadcast end(s) according to the connection selection result. After receiving confirmation result(s) of the second live broadcast end(s), connection relationship between the first live broadcast end and at least one second live broadcast end may be established according to the confirmation result(s). The connection relationship may be established between the first live broadcast end and the at least one second live broadcast end confirming to connect, e.g., recording the connection relationship in a connection record. Respective user information of each live broadcast end in a live broadcast group is recorded as connection data. For example, for each live broadcast end, user identification, live broadcast room information, and live broadcast service provider information may be recorded. Relationship data includes correspondence relationship between the first live broadcast end and the second live broadcast end in the group. Furthermore, the first live broadcast end, i.e., the live broadcast user who initiated the connection, may be marked, such as adding an initiation mark, etc.

Step 208: Receive original live broadcast data from the first live broadcast end and the at least one second live broadcast end according to the confirmation result(s).

Step 210: Process the original live broadcast data to generate final live broadcast data.

The first live broadcast end and the at least one second live broadcast end may upload respective original live broadcast data to the server of the live broadcast system, and subsequently, final live broadcast data is generated by processing the original live broadcast data based on the connection relationship.

Original live broadcast data uploaded by connected live broadcast ends is received, where the original live broadcast data may be audio data stream and image video data stream, which are uploaded in two data streams. The audio data stream and the image video data stream are then combined to obtain corresponding original live broadcast data. Alternatively, the original live broadcast data may be original live stream in which audio and images have been combined into a video data stream. For example, when using a shared live broadcast device, each live broadcast end may upload an audio data stream and a video data stream that are collected through the shared live broadcast device during live broadcast, and the audio data stream and the video data stream are then combined to obtain corresponding original live broadcast data.

For live broadcast ends in a live broadcast group, since live broadcast of each live broadcast end is in connection form, respective original live broadcast data of the live broadcast ends in the live broadcast group needs to be combined in order to determine corresponding final live broadcast data. In other words, for connection form, original live videos of various connected live broadcast ends need to be combined into a final live video.

Therefore, the first live broadcast end and the at least one second live broadcast end may be determined according to the connection relationship, and respective original live broadcast data of each live broadcast end in the live broadcast group is then obtained, and combined according to setting rules to obtain at least one type of final live broadcast data.

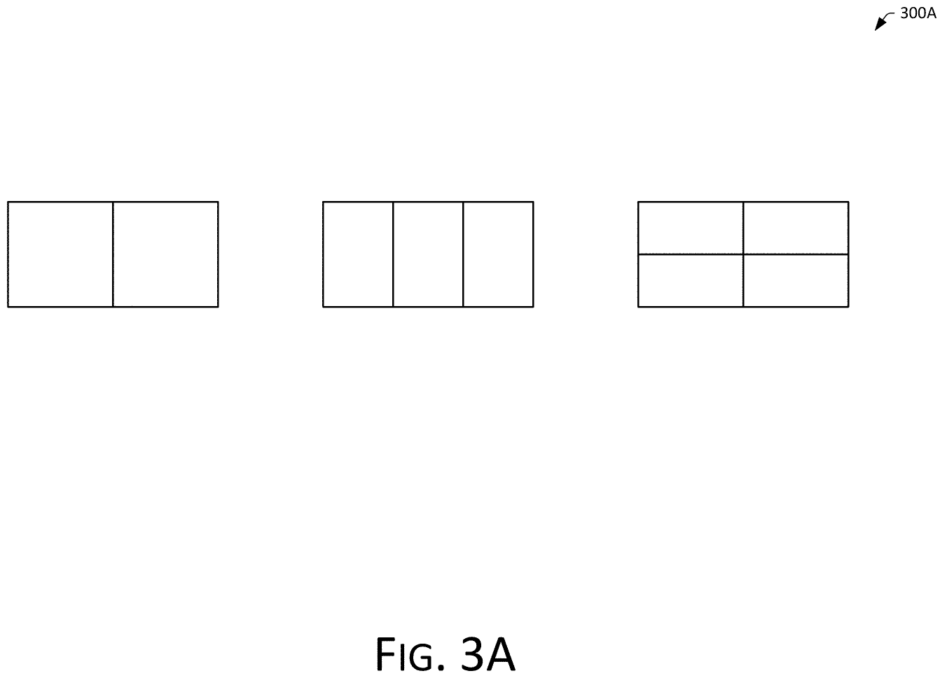

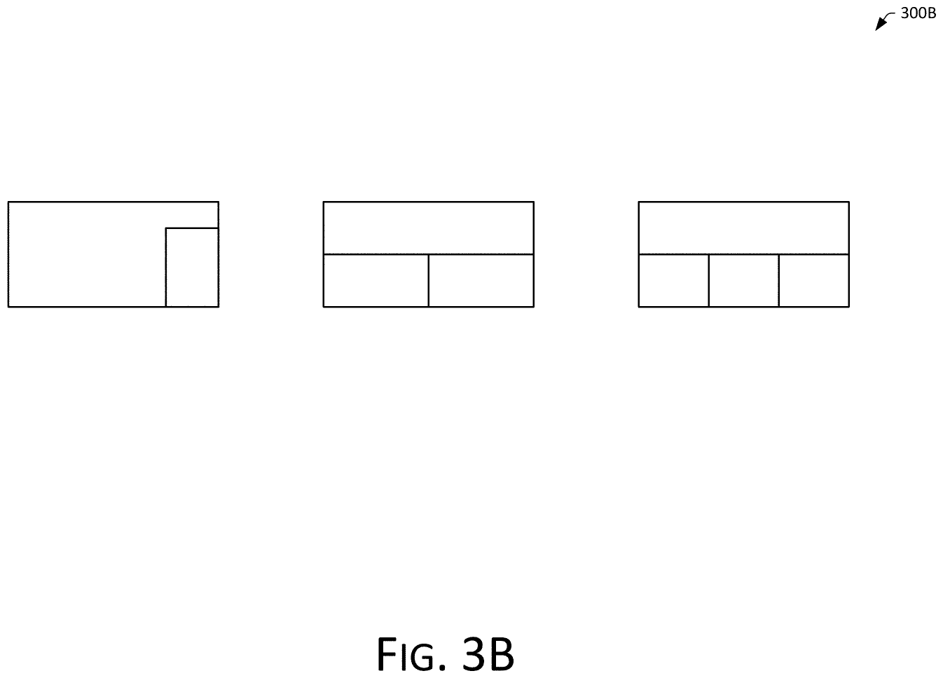

Combination rules for live broadcast data may be set and selected according to needs, and combination is performed based on required setting rules. For example, if the rule is set as an equal division rule, there is no need to distinguish between primary and secondary ends, and each live broadcast end may occupy the same screen space. In an example 300A as shown in FIG. 3A, when two, three, or four live broadcast ends connecting together, live broadcast data of each live broadcast end is spliced by equally dividing the screen space. Setting rules may also include partitioning rules, i.e., distinguishing between primary and secondary connections, different Occupancies of screen spaces are of different sizes and positions in different situations. For example, if the first live broadcast end acts as the primary, the first live broadcast end occupies the largest screen space, and screen spaces occupied by other live broadcast ends are relatively small. The screen spaces occupied by the other live broadcast ends may further be distinguished. For another example, if the main perspective is first persona view, corresponding final live broadcast data may be combined for each live broadcast end. In other words, for live broadcast room of each live broadcast end, its own live broadcast end is set as primary, and other live broadcast ends are set as secondary, and combination of live videos is correspondingly performed, as shown in an example 300B in FIG. 3B. The above-mentioned setting rules may be configured according to needs, which are not limited in the embodiments of the present disclosure.

Step 212: Send the final live broadcast data to one or more live broadcast service providers.

After final live video(s) is/are synthesized/combined, pushing may be performed to realize the connection of live broadcast ends. Respective final live broadcast data corresponding to each connected live broadcast end may be sent to the corresponding live broadcast end. The respective final live broadcast data corresponding to each connected live broadcast end may also be sent to server of the respective live broadcast service provider of the corresponding live broadcast end, to enable each server to push final live broadcast data to user devices corresponding to users who watch the live broadcast to complete live broadcasting.

If a live broadcast end is connected to the live broadcast collaborative server through the server of the live broadcast service provider, final live broadcast data for this type of live broadcast end is forwarded by the server of the live broadcast service provider. In other words, during phases such as initiation and execution of connection, if the live broadcast device directly interacts with the live broadcast collaborative server, various types of data may be sent directly by the live broadcast collaborative server. If the live broadcast device does not directly interact with the live broadcast collaborative server, forwarding is performed by the server of the live broadcast service provider thereof.

In the process of connection, if a second live broadcast end in the connected live broadcast group withdraws from the connection, data of the second live broadcast end that has withdrawn is deleted from the record corresponding to the connected live broadcast group, which includes deleting data corresponding to the second live broadcast end that has withdrawn, such as user name, user identification and other data, from connection data, and deleting the second live broadcast end from relationship data. After that, live broadcast data of the second live broadcast end that has withdrawn from the connection will no longer be combined with original live broadcast data of live broadcast end(s) in the connected live broadcast group. If the first live broadcast end withdraws from the connection, such withdrawal instruction may be understood as an end instruction for the connection, and the connected live broadcast group may be disconnected accordingly, and the connection is ended.

Based on the above embodiments, the embodiments of the present disclosure also provide a live broadcast interaction method, which enables the first live broadcast end to simultaneously perform live broadcast on multiple live broadcast service providers through a live broadcast collaborative server.

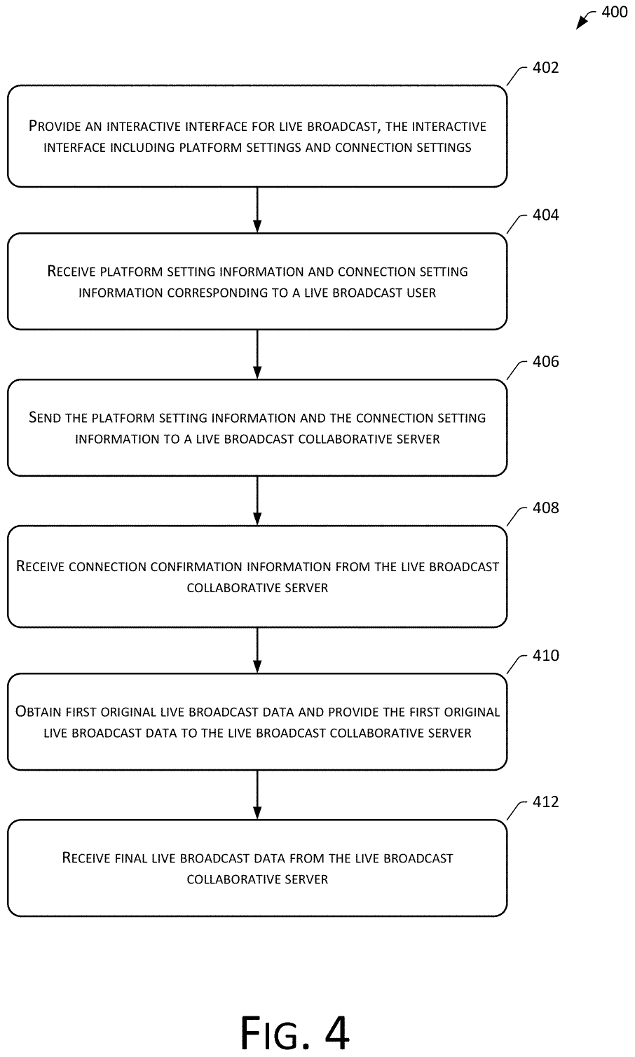

Referring to FIG. 4, a flowchart of another exemplary live broadcast interaction method 400 of the present disclosure is shown.

Step 402: Provide an interactive interface for live broadcast, the interactive interface including platform settings and connection settings.

A live broadcast collaborative server may provide a live broadcast interactive interface, and send the live broadcast interactive interface to a first live broadcast end, thereby displaying the live broadcast interactive interface on the first live broadcast end. The interactive interface includes platform settings and connection settings. The platform settings include multiple selectable live broadcast service providers, and the connection settings include multiple selectable second live broadcast ends.

The platform settings may provide multiple selectable live broadcast service providers, and one or more live broadcast service providers may be selected, so that a first live broadcast end may conduct live broadcast on one or more live broadcast platforms through the live broadcast collaborative server. The first live broadcast end may correspond to different live broadcast accounts on different live broadcast platforms, and the live broadcast collaborative server may obtain respective live broadcast account of the first live broadcast end on each live broadcast platform, so as to log into corresponding account(s) to provide live broadcast services based on one or more selected live broadcast platforms.

The connection settings may provide multiple selectable second live broadcast ends, such as user names of second live broadcast ends, identifications of live broadcast rooms, etc. Apparently, in some scenarios, the connection settings may also set some connection requirements, and a list returned from live broadcast collaborative services is received for determining multiple selectable second live broadcast ends.

When a shared live broadcast device is used, the live broadcast user may obtain authorization to use the device by scanning a code or other methods. Therefore, after scanning identification code, such as QR code, of the shared live broadcast device through a terminal device such as a mobile phone, the user may authorize his/her own identity information to the live broadcast collaborative server. For example, a device usage request may be sent to the live broadcast cooperative server, and the device usage request may include identity information. The live broadcast collaborative server determines a live broadcast account of the live broadcast user based on the identity information, logs into the live broadcast account, and returns a corresponding device usage result to the terminal device. An instruction may also be sent to the shared live broadcast device, and the shared live broadcast device may log into the live broadcast account, and live broadcast processing may be performed subsequently. In this embodiment, when the user scans a code for login authorization, the identity information authorized by such code scanning may be bound to a live broadcast account, so that the live broadcast account may be determined based on the identity information. When a live broadcast user uses a shared live broadcast device for the first time, if he/she has no live broadcast account before, a live broadcast account may be created based on the identity information. If he/she already has a live broadcast account, the live broadcast account may be bound to the identity information, and he/she may log in directly when using it again. A provision of the above live broadcast account may be based on a provision of the user terminal.

In some other embodiments, identity information authorized by code scanning and the live broadcast account of the live broadcast user may not be bound together. In other words, after passing authorization to use the shared live broadcast device by code scanning, the shared live broadcast device, which serves as the first live broadcast end, may display a login interface thereon. The user enters login information in the login interface, and then uploads the login information to the live broadcast collaborative server to log into the live broadcast account of the live broadcast user for performing live broadcast. In the embodiments of this application, the live broadcast account may be an account in the live broadcast collaborative server or an account in a live broadcast platform. The live broadcast collaborative server may also record other accounts associated with the account, in order to facilitate and enable the live broadcast user to perform live broadcast on live broadcast platforms of one or more live broadcast service providers.

Step 404: Receive platform setting information and connection setting information corresponding to the live broadcast user.

Step 406: Send the platform setting information and the connection setting information to the live broadcast collaborative server.

Based on selections associated with the live broadcast settings and the connection settings through the interactive interface above, the live broadcast end may receive platform setting information and connection setup information corresponding to the live broadcast user, and then send it to the live broadcast collaborative server.

Step 408: Receive connection confirmation information from the live broadcast collaborative server.

The live broadcast collaborative server may perform steps for conducting the connection, such as steps of providing list, sending request, receiving confirmation result, etc. in the above embodiments, thereby generating the connection confirmation result. The connection confirmation result includes at least one second live broadcast end that agrees to connect. In this way, the first live broadcast end may receive a connection confirmation from the live broadcast cooperative server and confirm the execution of the connection.

Step 410: Obtain first original live broadcast data and provide the first original live broadcast data to the live broadcast collaborative server.

After completing the live broadcast settings and connection settings, live broadcasting may be performed. The first live broadcast end may provide original live broadcast data (which may be called as first original live broadcast data to facilitate distinction), which is sent to the live broadcast collaborative server.

Step 412: Receive final live broadcast data from the live broadcast collaborative server.

The live broadcast collaborative server may perform processing, such as data combination in the foregoing embodiments, etc., to obtain final live broadcast data, which is then fed back to the first live broadcast end. The final live broadcast data includes at least a portion of the first original live broadcast data.

Video setting information corresponding to the live broadcast user may also be received. The video setting information is sent to the live broadcast collaborative server, wherein the final live broadcast data conforms to the video setting information. The video setting information is used to set combination rules for videos. The server may determine the combination rules based on the video setting information to perform final video combination. In other scenarios, the video setting information may also include other setting information of live broadcast data, such as special effects information, beautification information, etc., so that corresponding processing, such as special effects, beautification, etc. is added to the final live broadcast data.

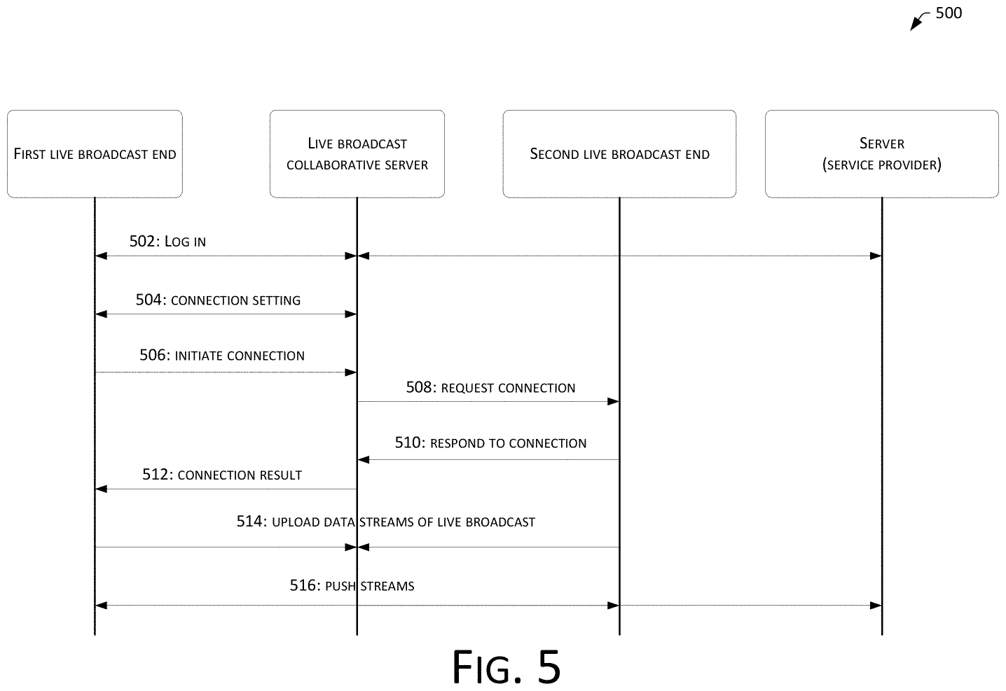

Based on the above-mentioned embodiments, the embodiments of the present disclosure provide a live broadcast interaction method, which describes a process 500 of interactive processing between a live broadcast end and a live broadcast cooperative server from the perspective of interaction, as shown in FIG. 5.

Step 502: A first live broadcast end logs in a live broadcast account on a live broadcast device.

When live broadcast user wants to use a live broadcast device, such as a shared live broadcast device, etc., he/she may perform authorization and confirmation by code scanning, pre-application (such as appointed time), etc. After receiving enable instruction, the shared live broadcast device may be enabled, and the live broadcast user may then enter login information on the shared live broadcast device. After receiving the login information, the shared live broadcast device may upload the login information to the live broadcast collaborative server. The live broadcast collaborative server may conduct login based on the login information. The live broadcast user may act as a first live broadcast end for performing live broadcast.

In some examples, the login information may include account information, such as user name and password of the live broadcast user, and may also include service provider information such as the live broadcast service provider to which the live broadcast user belongs. As such, the account information may be sent to a server of the corresponding live broadcast service provider for performing login verification, and login may be performed after the verification is passed. In other scenarios, the live broadcast collaborative server may also interact with the live service provider's server to share user information in advance. Based on the login information, the live broadcast service provider to which the live broadcast user belongs may thereby be determined and login verification may be performed. After the verification is passed, the server of the service provider sends a corresponding login instruction, so as to realize the login of the live broadcast user as the first live broadcast end on a corresponding live broadcast platform.

The first live broadcast end may start live broadcasting after login is completed, and may then connect to other live broadcast ends. In other scenarios, the first live broadcast end may also connect to other live broadcast ends before live broadcasting is started. The present disclosure does not have any restrictions on the timing of connection.

If live broadcast is started before connection, audio data stream and video data stream of original live broadcast data may be collected and uploaded through the first live broadcast end. During the progress of live broadcasting, the audio data stream and the video data stream may be collected and uploaded through a live broadcast device. For example, the audio data stream and the video data stream may be collected through a microphone and a camera respectively, which are uploaded to the live broadcast collaborative server using a network device after processing by a host device. The live broadcast collaborative server pushes the streams to a corresponding live broadcast platform for live broadcasting. Connection setting may then be performed to initiate a connection.

Step 504: The first live broadcast end performs connection setting.

Upon the live broadcast user deciding to conduct live broadcast in connection with other live broadcast users, the live broadcast user may be regarded as the first live broadcast end, and a request may be sent to the live broadcast collaborative server, so that connection settings may be made. An interactive interface of the live broadcast provided by the live broadcast cooperative server may be obtained, and the interactive interface of the live broadcast may be displayed. The interactive interface of the live broadcast includes connection setting controls, such as platform setting controls, connection setting controls, and the like.

The live broadcast user may trigger a corresponding connection control item on the live broadcast interface, and a connection is initiated through the connection control item. Accordingly, a connection setting request may be generated and sent to the live broadcast cooperative server, so that corresponding page data may be received. Based on the page data, an interactive interface of the live broadcast is displayed in the live broadcast device of the first live broadcast end, and the interactive interface of the live broadcast includes connection setting control items.

The connection setting control items are used to configure the connection. For example, a connection setting control item may be used to set a live broadcast platform to be connected as the live broadcast service provider, or may specify a connected host, such as a name of an broadcaster (or a host name), identification of a live broadcast room, etc., or may also set some requirements to filter broadcasters in a relatively large scope in order to select broadcasters for performing a connection. For example, by setting requirements such as a type of live broadcast, it is possible to receive selectable broadcasters returned from the live broadcast collaborative server. An broadcaster may be selected as a second live broadcast end among these selectable broadcasters, and a connection is thereby applied for. Therefore, the connected second live broadcast end and the live broadcast service provider to which the second live broadcast end belongs may be determined according to triggering of the connection setting control.

Correspondingly, the live broadcast collaborative server may receive query conditions, perform query for connection query information according to the query conditions. The connection query information includes: server information and/or user information. The live broadcast collaborative server may also feedback the connection query information. Based on different query conditions, exact matching or smart matching may be performed for the connection. For example, if the query conditions include a designated second live broadcast end, i.e. a designated broadcaster, a corresponding second live broadcast end may be accurately matched. For another example, the query conditions may be conditions specific to a live broadcast service provider and a live broadcast end, matching may be performed based on these query conditions to determine broadcaster(s) satisfying these conditions. For example, matching may be performed according to type of broadcaster, identity information, etc., or recommendation may be made based on historical connection data of the first live broadcast end, etc.

Designated second live broadcast end(s) may be selected on the interactive interface of the live broadcast to initiate connection(s) with the second live broadcast end(s).

Step 506: The first live broadcast end generates a connection initiation request corresponding to the second live broadcast end, and sends the connection initiation request.

Upon determining the second live broadcast end and the live broadcast service provider to which the second live broadcast end belongs, connection initiation request may be generated. For example, user identification of the second live broadcast end and service party information of the live broadcast service provider are added to the connection initiation request, which is sent to the live broadcast collaborative server.

Step 508: The live broadcast cooperative server determines at least one second live broadcast end according to the connection initiation request, and sends connection request to the live broadcast device of the at least one second live broadcast end.

The connection initiation request is sent by the live broadcast device of the first live broadcast end, and the second live broadcast end to be connected is determined according to the connection initiation request. At least one second live broadcast end may be determined from the connection initiation request, and connection request is sent to live broadcast device of the second live broadcast end separately. If the second live broadcast end also utilizes the live broadcast device of the live broadcast collaborative server, the live broadcast collaborative server may directly send the connection request to the live broadcast device of the second live broadcast end. If the live broadcast device of the second live broadcast end does not belongs to live broadcast device of the live broadcast collaborative server, the server may forward the connection request to the corresponding second live broadcast end through server of the live broadcast service provider.

Step 510: The second live broadcast end sends a connection response.

The second live broadcast end may receive a connection request from the first live broadcast end during live broadcasting. For example, the connection request is displayed as prompt information, so that the second live broadcast end may confirm whether to connect or not, and provide a feedback after generating corresponding connection response. The connection response may include response to confirm the connection, or a response to reject the connection.

Step 512: A connection confirmation result is generated and fed back.

The server receives the connection response fed back from live broadcast device of the at least one second live broadcast end, and determines at least one second live broadcast end confirming to connect. After receiving respective connection response(s) of the second live broadcast end(s), second live broadcast end(s) that confirm(s) to connect and the second live broadcast end(s) that refuse(s) to connect may be determined. A corresponding connection confirmation result may then be generated.

In addition, the server may establish a connection relationship between the first live broadcast end and each second live broadcast end that confirms to connect. The first live broadcast end and second live broadcast end(s) that confirm(s) to connect may be treated as live broadcast ends to establish a live broadcast end group. Connection data corresponding to the live broadcast end group and relationship data between the live broadcast ends may also be determined.

User information of each live broadcast end in the live broadcast end group may be recorded as connection data. For example, for each live broadcast end, user identification, information of the live broadcast room, and information of the live broadcast service provider to which it belongs, etc., may be recorded. Relationship data includes correspondence relationship between the first live broadcast end and the second live broadcast end(s) in the live broadcast end group. The first live broadcast end, i.e., the live broadcast user who initiates the connection, may be edited, such as adding an initiation identifier, etc., may also be added to the connection data.

In this way, connection status during the live broadcast may be recorded in the server, and connection between the live broadcast ends may be realized.

Step 514: The first live broadcast end and the second live broadcast end(s) may send respective original live broadcast data to the live broadcast cooperative server. In other scenarios, the second live broadcast end may send the original live broadcast data to the server of the live broadcast service provider, and the live broadcast service provider forwards the original live broadcast data to the live broadcast collaborative server.

The original live broadcast data may be transmitted in separate forms of audio data stream and video data stream. The audio data stream and the video data stream may then be combined to obtain corresponding live broadcast data by the live broadcast collaborative server. In the progress of live broadcast, each live broadcast end may upload audio data stream and video data stream collected by the live broadcast device, and the audio data stream and the video data stream are then combined to obtain live broadcast data corresponding to each live broadcast user.

For the live broadcast end in the live broadcast end group, since the live broadcast of each live broadcast end is in connection form, respective live broadcast data of the live broadcast ends in the live broadcast end group need to be combined to determine corresponding final live broadcast data. A process of combination is similar to the above-mentioned implementations, and details can be referenced to the parts of the above-mentioned embodiments.

Step 516: Return final live broadcast data.

After completion of live broadcast data combination, stream pushing may be performed to realize the connection of the broadcasters. Respective final live broadcast data corresponding to each live broadcast end may be sent to the live broadcast device of the respective live broadcast end, and the respective final live broadcast data corresponding to each live broadcast end may also be sent to the server of the live broadcast service provider corresponding to the respective live broadcast end, so that each server push the final live broadcast data to user devices corresponding to users watching the live broadcast to complete live broadcasting.

If the live broadcast device of the live broadcast end is connected to the server through the server of the live broadcast service provider, final live broadcast data for this type of live broadcast end is forwarded by the server of the live broadcast service provider. In other words, during phases of initiation and execution of connection, if the live broadcast device directly interacts with the server, various types of data are sent directly by the server. If the live broadcast device does not directly interact with the server, forwarding is performed by the server of the live broadcast service provider thereof.

During the connection, if a live broadcast end in the live broadcast group withdraws from the connection, data of the live broadcast end that has withdrawn is deleted from the record corresponding to the live broadcast group, which includes deleting data corresponding to the live broadcast end that has withdrawn, such as user name, user identification and other data, from connection data, and deleting the live broadcast end from relationship data. After that, live broadcast data of the live broadcast end that has withdrawn from the connection will no longer be combined with original live broadcast data of live broadcast end(s) in the live broadcast group. If the first live broadcast end withdraws from the connection, such withdrawal instruction may be understood as an end instruction for the connection, and the live broadcast group may be disconnected accordingly, and the connection is ended.

Thus, through the above process, connection between various live broadcast users may be realized, and the connection is not limited to a single live broadcast service provider, thus realizing integration processing of multiple live broadcast service providers, and improving the scalability.

The server end of the live broadcast system is connected to servers of multiple live broadcast service providers to realize interactions between the live broadcast service providers, so that a first live broadcast end may initiate a connection, and establish a live broadcast end group with a second live broadcast end that confirms to connect. Selection of the live broadcast end is not limited to the same live broadcast service provider. Live broadcast data of live broadcast ends in the live broadcast end group may then be combined, and final live broadcast data is fed back to live broadcast devices of the live broadcast ends, and streams are pushed to respective servers of the live broadcast service providers to which the live broadcast ends belong, thus being able to realize connections across live broadcast service providers and improve the scalability of live broadcasting.

Based on the foregoing embodiments, this embodiment also provides a live broadcast interaction method, which is applied to a server.

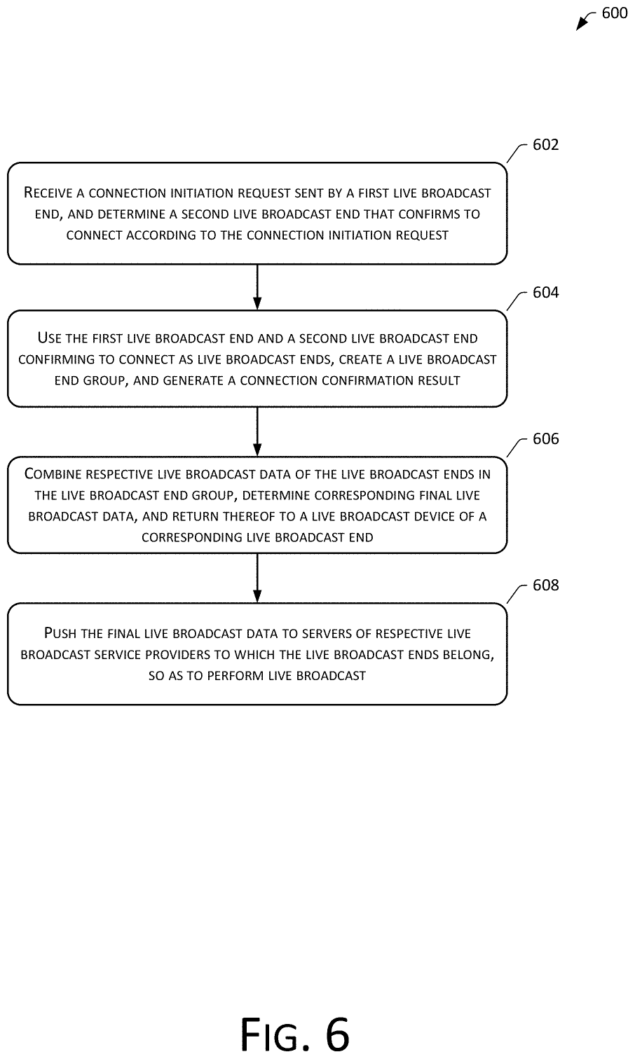

Referring to FIG. 6, a flowchart of an exemplary live broadcast interaction method 600 of the present disclosure is shown.

Step 602: Receive a connection initiation request sent by a first live broadcast end, and determine a second live broadcast end that confirms to connect according to the connection initiation request.

A live broadcast collaborative server may connect to servers of different live broadcast service providers, and thereby support live broadcast users to use live broadcast devices and log into various live broadcast platforms for performing live broadcasts. The live broadcast user uses the live broadcast device to connect to the server, and live broadcasting is realized based on interactions between the server and the servers of the live broadcast service providers.

During the progress of live broadcasting, connecting (i.e., making a connection) with other live broadcast users is desirable, connection may be initiated. After connection-related settings are completed, the live broadcast collaborative server provides a list of one or more second live broadcast ends that are connectable to the first live broadcast end. Upon the selection is made, the first live broadcast end may send a connection initiation request, and the server may receive the connection initiation request accordingly. At least one second live broadcast end may be determined according to the connection initiation request, and a connection request is sent to the live broadcast device of the at least one second live broadcast end. A connection response returned by the live broadcast device of the at least one second live broadcast end is received, and at least one second live broadcast end that confirms to make the connection is determined.

The connection initiation request may include user information of the second live broadcast end requesting to connect and service party information of the live broadcast service provider to which second live broadcast end belongs. The user information includes, for example, user identification, user name, identification of the live broadcast room, name of the live broadcast room, etc. The service party information includes, for example, name and identification, etc., provided by the live broadcast service provider. In this way, the second live broadcast end that wants to connect may be determined. One or more second live broadcast ends may be determined. For each second live broadcast end, connection request is then sent to corresponding live broadcast device. Each live broadcast user may choose to join or reject the connection, and correspondingly, connection response returned from the live broadcast device of the second live broadcast end may be received. Based on the connection response, determination is made as to whether the live broadcast user joins the connection, and at least one second broadcast end confirming to connect may be determined.

If the first live broadcast end wants to connect with other live broadcast users during the live broadcast, connection may be set through an interactive interface of the live broadcast, thereby initiating the connection. Therefore, an interactive interface for live broadcast may be provided, and the interactive interface for live broadcast may include: connection setting control items. The connection setting control items may be used to perform connection settings, which may trigger settings such as connection query and initiation.

Based on triggering of a connection setting control item, corresponding query conditions may be generated. The query conditions may be sent to the server, so that the server may query connection query information according to the query conditions. The connection query information includes: service party information and/or user information. The connection query information is returned. The user information includes, for example, user identification, user name, identification of the live broadcast room, name of the live broadcast room, etc. The service party information includes, for example, name and identification of the live broadcast service provider. This thus facilitates the first live broadcast end to select a second live broadcast end. For example, the first live broadcast end inputs a user name of a second live broadcast end in the interactive interface of the live broadcast, so that the user name is used as a query condition. After one or more corresponding second live broadcast ends are determined, corresponding connection query information may be obtained. For another example, the first live broadcast end enters a type of second live broadcast end in the interactive interface of the live broadcast as a query condition, and a corresponding server may perform a query based on the query condition to determine corresponding connection query information.

In the embodiments of the present disclosure, since connection is a form in which two or more live broadcast users conduct live broadcast together, it is usually required that the connected live broadcast users are all online, i.e., the live broadcast ends are required to be in live broadcasting state. In some scenarios, if a second live broadcast end is offline, i.e., live broadcast thereof is not started, prompt information may also be sent to the second live broadcast end, so that the second live broadcast end starts the live broadcast before connecting.

In other scenarios, the connection may also be in the form of scheduled connection, i.e., the first live broadcast end may set up a scheduled time for scheduled connection when initiating the connection, such as starting the connection at 8 pm, etc. Therefore, for live broadcast ends in the live broadcast end group, if they are in live broadcasting state when the scheduled time is reached, the connection may be automatically started.

Step 604: Setting the first live broadcast end and the second live broadcast end confirming to connect as live broadcast ends, create a live broadcast end group, and generate a connection confirmation result.

The first live broadcast end and the second live broadcast end that confirms to connect may be treated as live broadcast ends. Connection data corresponding to the live broadcast end group is determined, and relationship data between the live broadcast ends is established to create the live broadcast end group. In other words, connection relationship of live broadcast users is recorded in the server, so as to realize a connection between the live broadcast users.

For example, a record of the live broadcast end group may be recorded in a database of the server, which includes group identification of the live broadcast end group, user identification of live broadcast ends in the live broadcast end group, service party information of live broadcast service provider(s), current live broadcasting status, and other information. Data such as the first live broadcast end that initiates this connection is also recorded.

The live broadcast ends in the live broadcast end group may then be connected.

Step 606: Combine respective live broadcast data of the live broadcast ends in the live broadcast end group, determine corresponding final live broadcast data, and return to live broadcast devices of corresponding live broadcast ends.

Corresponding video data stream and audio data stream may be obtained from live broadcast devices of the live broadcast ends and be combined to obtain live broadcast data. Each live broadcast user may also be able to set corresponding personalized settings during the live broadcast, such as beautification, prettification, special effects, etc. These personalized settings may be added in the final live broadcast data, so that combined live broadcast data is added with personalized live broadcast data.

A determination may be made as to whether a live broadcast user belongs to a live broadcast end in the live broadcast end group. If confirmed, connection and combination are performed. Otherwise, the live broadcast proceeds as normal, live broadcast data is fed back to the live broadcast device of the corresponding live broadcast user, and pushed to the live broadcast service provider server, for sending to user devices of users watching the live broadcast to realize live broadcasting.

The live broadcast data of live broadcast ends may be combined by connection, wherein the live broadcast data of the live broadcast ends may be combined based on a preset rule to obtain at least one final live broadcast data. The combination method is as described in the above embodiments. In addition, the connection settings may include corresponding connection effect settings, which may also be added with conditional data, such as screen special effects, sound special effects, and corresponding link data, etc., during the process of combination.

Step 608: Push the final live broadcast data to servers of respective live broadcast service providers to which the live broadcast ends belong, so as to perform live broadcast.

The final live broadcast data combined by the connection may be fed back to the live broadcast device of each live broadcast end for playing in the live broadcast device of the live broadcast end. Alternatively, the final live broadcast data may be pushed to the server of the live broadcast service provider to which the live broadcast end belongs, so that the server of the live broadcast service provider sends the final live broadcast data to user devices of users watching the live broadcast, so that the corresponding online video may be watched.

During the connection, if a live broadcast end in the live broadcast group withdraws from the connection, data of the live broadcast end that has withdrawn is deleted from the record corresponding to the live broadcast group, which includes deleting data corresponding to the live broadcast end that has withdrawn, such as user name, user identification and other data, from connection data, and deleting the live broadcast end from relationship data. After that, live broadcast data of the live broadcast end that has withdrawn from the connection will no longer be combined with original live broadcast data of live broadcast end(s) in the live broadcast group.

If the first live broadcast end withdraws from the connection, such withdrawal instruction may be understood as an end instruction for the connection, and the live broadcast group may be disconnected accordingly, and the connection is ended.

Based on the foregoing embodiments, this embodiment also provides a live broadcast interaction method, which may be utilized by a live broadcast device at a first live broadcast end.

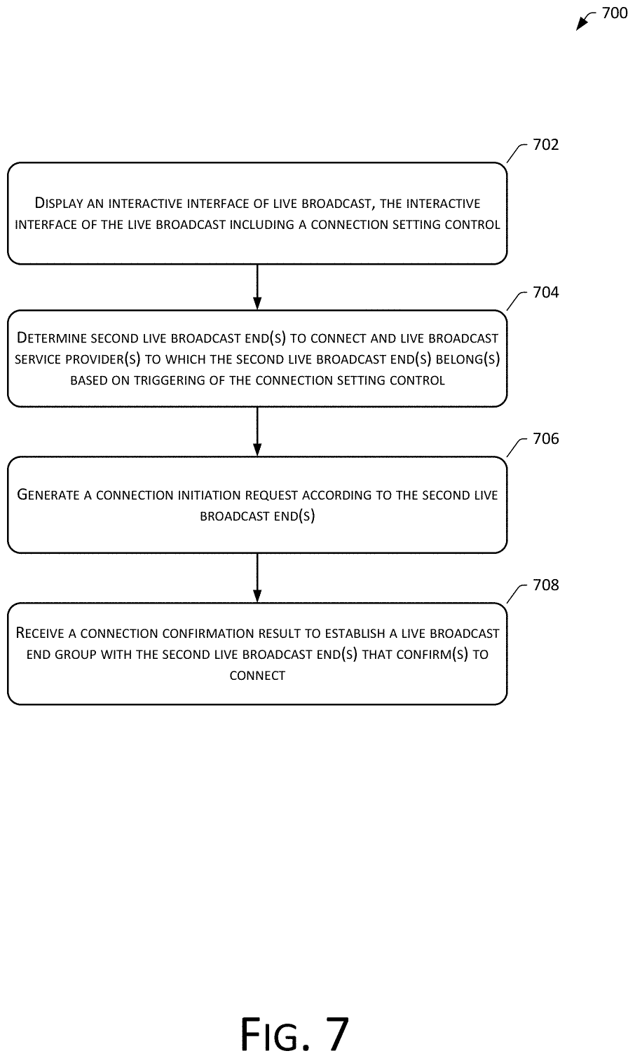

Referring to FIG. 7, a flowchart of another exemplary live broadcast interaction method 700 of the present disclosure is shown.

Step 702: Display an interactive interface of live broadcast, the interactive interface of the live broadcast including a connection setting control.

User may use a shared live broadcast device to conduct live broadcast. In an example, the shared live broadcast device is used by scanning a code. In this case, the live broadcast user may scan barcode information, such as QR code on the live broadcast device, using a mobile phone, etc., and then perform authorization by logging in or other methods. After the authorization is passed, the live broadcast device may be started for use. One or more live broadcast apps (Applications) may be launched on the live broadcast device, and login may be performed on a corresponding APP. In other examples, a shared live broadcast APP may also be provided, so that one or more live broadcast platforms may be selected and account login may be performed in this live broadcast APP. In some examples, it's possible to associate accounts of the live broadcast user in various live broadcast platforms by login to a single account of the user in the app. In other scenarios, accounts may also be separately logged in on different live broadcast platforms.

Upon completion of the login, a live broadcast may be started. During the live broadcast, the live broadcast user may initiate connection if he/she desires to hold a connected live broadcast. In this case, connection settings may be requested. An interactive interface of the live broadcast may be obtained from the server and the interactive interface of the live broadcast may be displayed.

Step 704: Determine second live broadcast end(s) to connect and live broadcast service provider(s) to which the second live broadcast end(s) belong(s) based on trigger of the connection setting control item.

The interactive interface of the live broadcast includes connection setting control items, and the connection setting control items are used for setting connections, e.g., selecting a second live broadcast end or a type of second live broadcast end desired to connect, etc. One or more live service providers may be specified or not with respect to the second live broadcast end, so that corresponding query conditions may be determined based on the connection setting control items and sent to the server. The server may perform search based on the query conditions to determine second live broadcast end(s) that satisf(ies) the query conditions and obtain corresponding connection query information. The connection query information may be displayed on the interactive interface of the live broadcast for choice of one or more second live broadcast ends desired, selection of second live broadcast end(s) to be connected and live broadcast service provider(s) to which the second live broadcast end(s) belong(s), and service party information and/or user information of the corresponding live broadcast end(s) is obtained.

Step 706: Generate a connection initiation request according to the second live broadcast end(s).

The service party information and/or the user information of the second live broadcast end(s) may be added to the connection initiation request, and the connection initiation request may be sent, so that a connection may be initiated to each second live broadcast end. Second live broadcast end(s) that confirm(s) to connect is/are determined based on connection response(s) of second live broadcast end(s). Therefore, the server treats the first live broadcast end and the second live broadcast end(s) that confirm(s) to connect as live broadcast ends to form a live broadcast end group, and may record corresponding connection data and relationship data. A connection confirmation result may also be generated and fed back to respective live broadcast devices of the live broadcast ends.

Step 708: Receive connection confirmation result to establish the live broadcast end group with the second live broadcast end(s) that confirm(s) to connect.

Both the first live broadcast end and the second live broadcast end(s) may feedback its connection confirmation result. The connection confirmation result may notify live broadcast users making the connection, or broadcast live user refusing to connect, etc., which may be determined according to needs.

After the connection is established, video data stream and audio data stream collected by live broadcast devices of live broadcast ends may be uploaded to the server. The server combines the video data stream and audio data stream to form live broadcast data for live broadcast users. Respective live broadcast data for the live broadcast users are further combined to obtain corresponding final live broadcast data, i.e., combining video data of all broadcasters included in this connection.

Step 710: Receive and play final live broadcast data, the final live broadcast data being combined based on live broadcast data of live broadcast ends in the live broadcast end group.

The live broadcast device of each live broadcast end may receive and play the final live broadcast data. Users who watch the live broadcast may obtain and play final live broadcast data based on stream pushed by the live broadcast service provider thereof, so as to realize watching of the live broadcast.

Based on the foregoing embodiments, an embodiment of the present disclosure also provides a live broadcast interaction method, which is applied to a live broadcast device at a second live broadcast end.

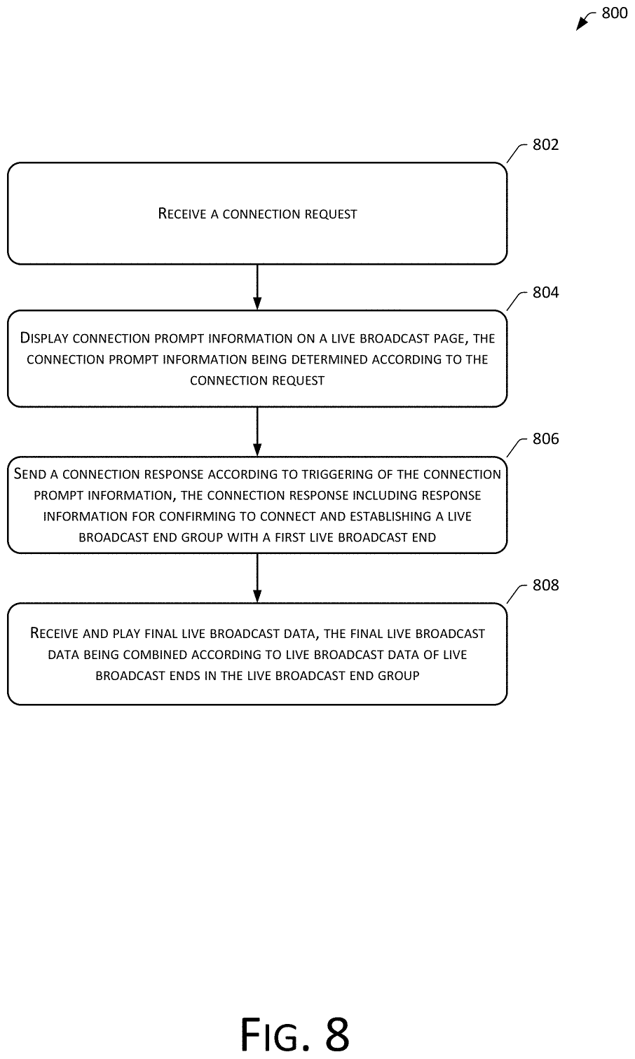

Referring to FIG. 8, a flowchart of another example live broadcast interaction method 800 of the present disclosure is shown.

Step 802: Receive a connection request.

Step 804: Display connection prompt information on a live broadcast page, the connection prompt information being determined according to the connection request.

A live broadcast device of each second live broadcast end may receive a connection request. If the second live broadcast end uses live broadcast device of the server, the server may directly send the connection request to such live broadcast device of the second live broadcast end. If the live broadcast device of the second live broadcast end is not live broadcast device of the server, the server may forward the connection request through a server of the live broadcast service provider corresponding to the second live broadcast end.

According to the connection request, connection notification information may be displayed on a live broadcast page of the second live broadcast end. The connection notification information may indicate the first live broadcast end that initiates the connection, or other second live broadcast ends that have confirmed to join the connection. As such, this facilitates the live broadcast end to choose whether to join the connection.

Step 806: Send a connection response according to trigger of the connection notification information, the connection response including response information for confirming to connect and establishing a live broadcast end group with a first live broadcast end.

The second live broadcast end may confirm whether to connect or not, and may provide a feedback by triggering the connection notification information. For example, the connection notification information may display a control item for join or refuse, so that the live broadcast user may confirm whether to join by triggering the control item, and generate and feedback corresponding connection response. The connection response may include response indicating confirmation to connect, or a response indicating rejection to connect. The connection notification information may also display other control items based on needs, such as control item for viewing details, etc., for viewing second live broadcast end that has agreed to connect and user information of the corresponding live broadcast user, etc.

Step 808: Receive and play final live broadcast data, the final live broadcast data being combined according to live broadcast data of live broadcast ends in the live broadcast end group.

Upon confirmation of the connection, the server subsequently receives video data stream and audio data stream collected by the live broadcast device of the live broadcast user for final live broadcast data, which may be combined with live broadcast data of other live broadcast end(s) in the live broadcast end group to form final live broadcast data. After that, the live broadcast device may receive and play the final live broadcast data. The final live broadcast data may also be pushed to the server of the live broadcast service provider, to which the live broadcast user belongs, thereby being able to push associated streams to users who watch the live broadcast.

In summary, the present disclosure may realize multi-person connection across live broadcast platforms, and may combine live broadcast data of live broadcast ends that participate in such live broadcast connection group, and then push associated streams to live broadcast devices of live broadcast ends and live broadcast devices of viewing users. In this way, the flexibility and scalability of live broadcast interaction are increased.

It should be noted that the method embodiments are all expressed as a series of action combinations for the sake of simplifying description, Nevertheless, one skilled in the art should understand that the embodiments of the present disclosure are not limited by the described sequence of actions, because certain steps may be performed in other order or concurrently according to the embodiments of the present disclosure. Furthermore, one skilled in the art should also understand that the embodiments described in the specification are all exemplary embodiments, and actions involved therein may not be necessarily required by the embodiments of the present disclosure.

Based on the above-mentioned embodiments, this embodiment also provides a live broadcast interactive apparatus, which is applied to a server applied to a live broadcast system. Such server may be formed by electronic devices such as a server (cluster). The server is connected to servers of multiple live broadcast service providers.

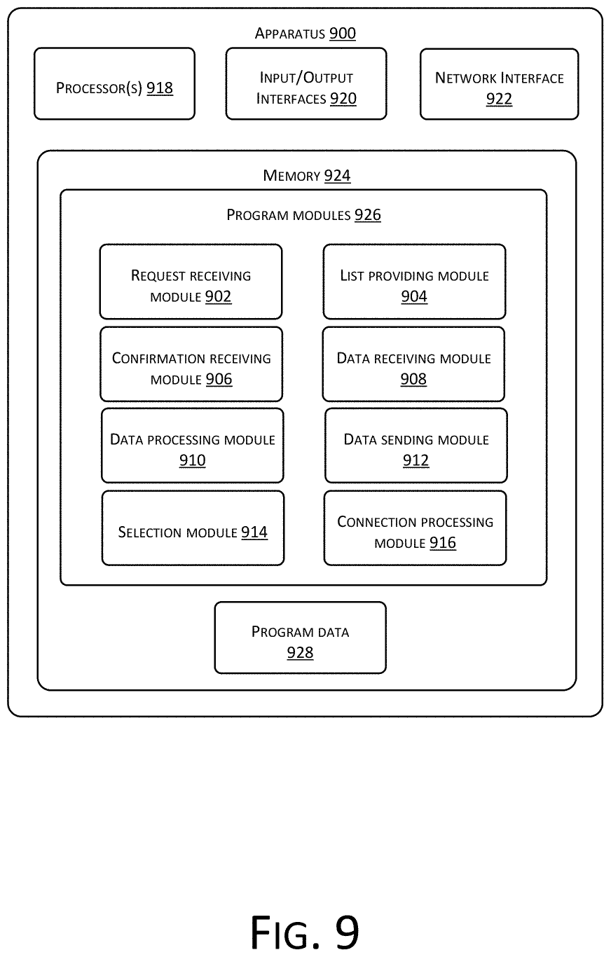

Referring to FIG. 9, a structural block diagram of a live broadcast interaction apparatus 900 according to the embodiments of the present disclosure is shown, which may specifically include the following modules:

a request receiving module 902 configured to receive a live broadcast request sent by a first live broadcast end;

a list providing module 904 configured to provide a list of one or more connectable second live broadcast ends to the first live broadcast end;

a confirmation receiving module 906 configured to receive a confirmation result from the first live broadcast end or a second live broadcast end;

a data receiving module 908 configured to receive original live broadcast data from the first live broadcast end and at least one second live broadcast end according to the confirmation result;

a data processing module 910 configured to process the original live broadcast data to generate final live broadcast data; and

a data sending module 912 configured to send the final live broadcast data to one or more live broadcast service providers.

The apparatus 900 further includes: a selection module 914 configured to determine and confirm identity information of the first live broadcast end, provide live broadcast selection information to the first live broadcast end according to the identity information, the live broadcast selection information including selectable second live broadcast end(s) and live broadcast service provider(s).

The confirmation receiving module 906 is further configured to receive a connection selection result from the first live broadcast end, the connection selection result including one or more designated second live broadcast ends, and send a connection request to the designated second live broadcast ends according to the connection selection result.

The data processing module 910 is configured to combine the original live broadcast data according to setting rules to generate the final live broadcast data.

The confirmation receiving module 906 is further configured to establish connection relationship between the first live broadcast end and the at least one second live broadcast end according to the confirmation result.

The confirmation receiving module 906 is further configured to receive a withdrawal request of a second live broadcast end, and delete the second live broadcast end from the connection relationship.

The apparatus 900 further includes: a connection processing module 916 configured to receive connection setting information of the first live broadcast end, and query one or more second live broadcast ends according to the connection setting information.

The request receiving module 902 is further configured to receive a connection initiation request from the first live broadcast end, the connection initiation request being generated according to second live broadcast end(s) selected in the list.

The confirmation receiving module 906 is configured to receive connection confirmation result(s) of the second live broadcast end(s).

The connection processing module 916 is configured to establish connection relationship between the first live broadcast end and the at least one second live broadcast end according to the connection confirmation result(s).

In implementations, the apparatus 900 may further include one or more processors 918, an input/output (I/O) interface 920, a network interface 922, and a memory 924. In implementations, the memory 924 may include program modules 926 and program data 928. The program modules 926 may include one or more of the foregoing modules as described in FIG. 9.

In implementations, the memory 924 may include a form of computer readable media such as a volatile memory, a random access memory (RAM) and/or a non-volatile memory, for example, a read-only memory (ROM) or a flash RAM. The memory 924 is an example of a computer readable media.

The computer readable media may include a volatile or non-volatile type, a removable or non-removable media, which may achieve storage of information using any method or technology. The information may include a computer readable instruction, a data structure, a program module or other data. Examples of computer readable media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

A live broadcast collaborative server end of a live broadcast system is connected to servers of multiple live broadcast service providers to realize interactions between the live broadcast service providers, so that a first live broadcast end may initiate connection and establish a live broadcast end group with second live broadcast end(s) that confirm(s) to make the connection. Selection of the live broadcast ends is not limited to the same live broadcast service provider. After that, live broadcast data of live broadcast ends in the live broadcast end group may be combined to final live broadcast data, which is fed back to respective live broadcast devices of the live broadcast ends, and streams are pushed to servers of respective live broadcast service providers to which the live broadcast ends belong. This may realize connections across live broadcast service providers and improve the scalability of live broadcast.

Based on the above-mentioned embodiments, this embodiment also provides a live broadcast interactive apparatus, which is utilized by the first live broadcast end. The live broadcast device of the first live broadcast end may include electronic devices, such as various types of audio and video acquisition devices, a host device, a network device, etc. The live broadcast device is connected to the server of a live broadcast system, and the server is connected to servers of multiple live broadcast service providers.

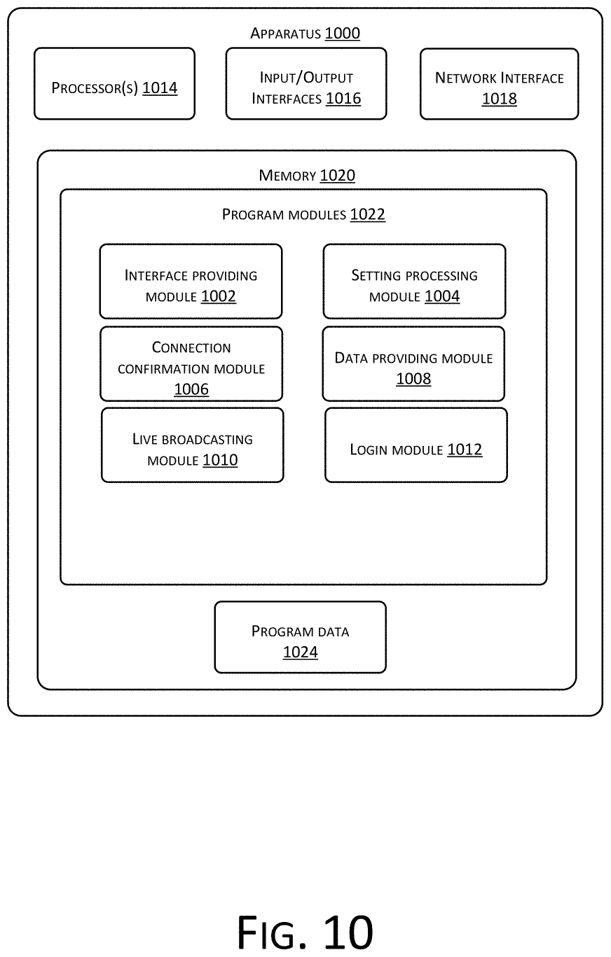

Referring to FIG. 10, a structural block diagram of another exemplary live broadcast interaction apparatus 1000 of the present disclosure is shown, which may specifically include the following modules:

an interface providing module 1002 configured to provide an interactive interface for live broadcast, the interactive interface including platform settings and connection settings;

a setting processing module 1004 configured to receive platform setting information and connection setting information corresponding to a live broadcast user, and send the platform setting information and the connection setting information to a live broadcast collaborative server;

a connection confirmation module 1006 configured to receive connection confirmation information from the live broadcast collaborative server;

a data providing module 1008 configured to obtain first original live broadcast data, and provide the first original live broadcast data to the live broadcast collaborative server; and

a live broadcasting module 1010 configured to receive final live broadcast data from the live broadcast collaborative server.

The platform settings include multiple selectable live broadcast service providers, the connection settings include multiple selectable second live broadcast ends, and the final live broadcast data includes at least a portion of the first original live broadcast data.

The setting processing module 1004 is further configured to receive video setting information corresponding to the live broadcast user, and send the video setting information to the live broadcast collaborative server, wherein the final live broadcast data conforms to the video setting information.

The final live broadcast data is composed of the first original live broadcast data and second original live broadcast data from one or more second live broadcast ends.

The apparatus 1000 further includes a login module 1012 configured to receive and upload login information, so as to log into a live broadcast account of the live broadcast user through a live broadcast end device for performing live broadcast.

In implementations, the apparatus 1000 may further include one or more processors 1014, an input/output (I/O) interface 1016, a network interface 1018, and a memory 1020. In implementations, the memory 1020 may include program modules 1022 and program data 1024. The program units 1022 may include one or more of the foregoing modules as described in FIG. 10.

In implementations, the memory 1020 may include a form of computer readable media as described in the foregoing description.

In summary, the present disclosure may realize a multi-person connection across live broadcast platforms, and may combine live broadcast data of live broadcast ends that participate in such live broadcast connection group, and then push associated streams to a live broadcast device of each live broadcast end and live broadcast devices of viewing users. In this way, the flexibility and scalability of live broadcast interaction are increased.

Based on the foregoing embodiments, the present disclosure also provides a live broadcast interactive system, which is used to be presented in an electronic device of a live broadcast user, so that the live broadcast user may perform live broadcast simultaneously on multiple live broadcast service providers through a live broadcast coordinator. The system includes:

a live broadcast interface unit configured to provide live broadcast setting options and receive settings inputted from the live broadcast user;

a video acquisition unit configured to shoot a video; and

a communication unit configured to transmit setting information and live broadcast data with the live broadcast coordinator.

The live broadcast interface unit includes: a platform setting interface, a connection setting interface, and a video setting interface, wherein:

the platform setting interface provides multiple selectable live broadcast service platforms,

the connection setting interface provides other selectable live broadcast users, and

the video setting interface provides selectable video setting parameters.

Various units of this embodiment are similar to corresponding parts of the foregoing embodiments, and therefore, reference may be made to the descriptions of the foregoing embodiments.

The embodiments of the present disclosure also provide a non-volatile readable storage medium. The storage medium stores one or more modules (programs). When being applied in a device, the one or more modules may cause the device to execute instructions for various method steps in the embodiments of the present disclosure.

The embodiments of the present disclosure provide one or more machine-readable media storing instructions thereon, which when executed by one or more processors, cause an electronic device to execute one or more methods described in the above-mentioned embodiments. In the embodiments of the present disclosure, the electronic device includes various types of devices, such as a terminal device, a server (cluster), etc.

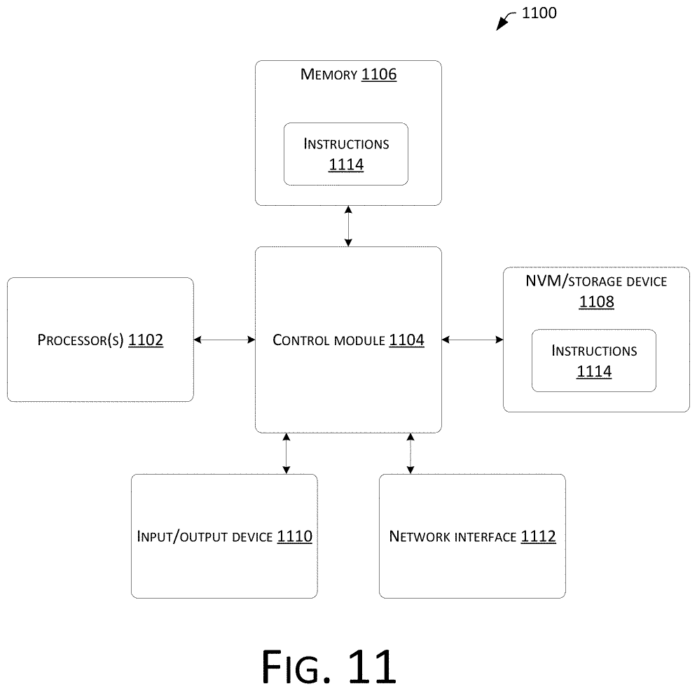

The embodiments of the present disclosure may be implemented as a device that uses any appropriate hardware, firmware, software, or any combination thereof to perform a desired configuration, and the device may include an electronic device, such as a terminal device, a server (cluster), etc. FIG. 11 schematically shows an exemplary apparatus 1100 that may be used to implement various embodiments described in the present disclosure.

In an embodiment of the present disclosure, FIG. 11 shows an exemplary apparatus 1100 having one or more processors 1102, a control module (chipset) 1104 coupled to at least one of the processor(s) 1102, a memory 1106 coupled to the control module 1104, a non-volatile memory (NVM)/storage device 1108 coupled to the control module 1104, one or more input/output devices 1110 coupled to the control module 1104, and a network interface 1112 coupled to the control module 1104.

The processor 1102 may include one or more single-core or multi-core processors, and the processor 1102 may include any combination of general-purpose processors or special-purpose processors (for example, graphics processors, application processors, baseband processors, etc.). In some embodiments, the apparatus 1100 may be used as a device, such as a terminal device, a server (cluster), etc., that is described in the embodiments of the present disclosure.

In some embodiments, the apparatus 1100 may include one or more computer-readable media (for example, the memory 1106 or the NVM/storage device 1108) having instructions 1114, and one or more processors 1102 that are configured to execute the instructions 1114 to implement modules to perform the actions described in the present disclosure in combination with the one or more computer-readable media.

In embodiments of the present disclosure, the control module 1104 may include any suitable interface controller to provide any suitable interface to at least one of the processor(s) 1102 and/or any suitable device or component in communication with the control module 1104.

The control module 1104 may include a memory controller module to provide an interface to the memory 1106. The memory controller module may be a hardware module, a software module, and/or a firmware module.

The memory 1106 may be used to load and store data and/or instructions 1114 for the apparatus 1100, for example. In implementations, the memory 1106 may include any suitable volatile memory, such as a suitable DRAM. In some embodiments, the memory 1106 may include a double data rate type quad synchronous dynamic random access memory (DDR4 SDRAM).

In embodiments of the present disclosure, the control module 1104 may include one or more input/output controllers to provide interfaces to the NVM/storage device 1108 and the input/output device(s) 1110.

For example, the NVM/storage device 1108 may be used to store data and/or instructions 1114. The NVM/storage device 1108 may include any suitable non-volatile memory (e.g., flash memory) and/or may include any suitable non-volatile storage device(s) (e.g., one or more hard drives (HDD), one or more compact disc (CD) drives, and/or one or more digital versatile disc (DVD) drives).

The NVM/storage device 1108 may include storage resources that are physically a part of a device on which the apparatus 1100 is installed, or may be accessed by the device and may not necessarily be a part of the device. For example, the NVM/storage device 1108 may be accessed using the input/output device(s) 1111 via a network.

The input/output device(s) 1110 may provide an interface for the apparatus 1100 to communicate with any other suitable devices. The input/output device 1110 may include a communication component, an audio component, a sensor component, etc. The network interface 1112 may provide an interface for the apparatus 1100 to conduct communications through one or more networks. The apparatus 1100 may communicate with one or more components in a wireless network for conducting wireless communications according to any of one or more wireless network standards and/or protocols, for example, conducting wireless communications by accessing a wireless network based on a communication standard, such as WiFi, 2G, 3G, 4G, 5G, etc., or a combination thereof.

In embodiments of the present disclosure, at least one of the processor(s) 1102 may be packaged with logic module of one or more controllers (e.g., memory controller modules) of the control module 1104. In some embodiments, at least one of the processor(s) 1102 may be packaged with logic module of one or more controllers of the control module 1104 to form a system in package (SiP). In some embodiments, at least one of the processor(s) 1102 may be integrated with the logic module of one or more controllers of the control module 1104 on the same mold. In some embodiments, at least one of the processor(s) 1102 may be integrated with logic module of one or more controllers of the control module 1104 on the same mold to form a system on chip (SoC).

In various embodiments, the apparatus 1100 may be, but is not limited to, a terminal device such as a server, a desktop computing device, or a mobile computing device (for example, a laptop computing device, a handheld computing device, a tablet computer, a netbook, etc.). In various embodiments, the apparatus 1100 may have more or fewer components and/or a different architecture. For example, in some embodiments, the apparatus 1100 includes one or more cameras, a keyboard, a liquid crystal display (LCD) screen (including touchscreen displays), a non-volatile memory port, multiple antennas, a graphics chip, an application specific integrated circuit (ASIC), and a speaker.

For the apparatus embodiments, the descriptions thereof are relatively simple due to their basic similarities to the method embodiments. For related parts, referenced may be made to respective parts of the descriptions of the method embodiments.

Various embodiments in this specification are described in a progressive manner. Each embodiment has a focus that is different from those of other embodiments. Same or similar parts between various embodiments may be referenced to each other.

The embodiments of the present disclosure are described with reference to flowcharts and/or block diagrams of methods, terminal devices (systems), and computer program products according to the embodiments of the present disclosure. It should be understood that each process and/or block in the flowcharts and/or block diagrams, and a combination of the processes and/or blocks in the flowcharts and/or block diagrams may be realized by computer program instructions. These computer program instructions may be provided to a processor of a general-purpose computer, a special-purpose computer, an embedded processor, or other programmable data processing terminal device to generate a machine, so that the instructions executed by the processor of the computer or other programmable data processing terminal device produce an apparatus used for realizing functions specified in one or more processes in the flowcharts and/or one or more blocks in the block diagrams.

These computer program instructions may also be stored in a computer-readable storage device that may guide a computer or other programmable data processing terminal device to perform operations in a specific manner, so that the instructions stored in the computer-readable storage device produce an article of manufacture that includes an instruction apparatus. Such instruction apparatus implements the functions specified in one or more processes in the flowcharts and/or one or more blocks in the block diagrams.

These computer program instructions may also be loaded into a computer or other programmable data processing terminal device, so that a series of operations are executed in the computer or other programmable terminal device to produce computer-implemented processing, so that the instructions executed in the computer or other programmable terminal device provide steps for implementing the functions specified in one or more processes in the flowcharts and/or one or more blocks in the block diagrams.

Although the exemplary embodiments of the embodiments of the present disclosure have been described, one skilled in the art may make additional changes and modifications to these embodiments once learning the basic creative concepts. Therefore, the appended claims are intended to be interpreted as including the exemplary embodiments and all the changes and modifications that fall within the scope of the embodiments of the present disclosure.

Finally, it should be noted that in this article, relational terms such as first and second are only used to distinguish one entity or operation from another entity or operation, and do not necessarily require or imply these entities or operations to have any such actual relationship or sequence therebetween. Moreover, terms “including”, “containing” or any other variants thereof are intended to cover a non-exclusive inclusion, so that a process, method, article, or terminal device that includes a series of elements includes not only those elements, but also other elements that are not explicitly listed, or also include elements that are inherent to this process, method, article, or terminal device. Without more restrictions, an element defined by a sentence “including a . . . ” does not exclude an existence of other identical elements in a process, method, article, or terminal device that includes such element.

A detailed description of live broadcast interaction methods and apparatuses, electronic devices, and storage media provided by the present disclosure is provided above. Specific examples are used in this article to illustrate the principles and implementations of the present disclosure. The description of the above embodiments is only used to help understand the methods and core ideas of the present disclosure. At the same time, for one skilled in the art, there could be changes in specific implementations and scopes of application according to the ideas of the present disclosure. In summary, the content of this specification should not be construed as a limitation to the present disclosure.

What is claimed is:

1. A method implemented by a live broadcast collaborative server, the method comprising:
receiving a live broadcast request sent by a first live broadcast end;
providing a list of one or more connectable second live broadcast ends to the first live broadcast end;
receiving a confirmation result from the first live broadcast end or at least one second live broadcast end;
receiving original live broadcast data of the first live broadcast end and the at least one second live broadcast end according to the confirmation result;
processing the original live broadcast data to generate final live broadcast data; and
sending the final live broadcast data to one or more live broadcast service providers.

2. The method according to claim 1, further comprising:
determining identity information of the first live broadcast end; and
providing live broadcast selection information to the first live broadcast end according to the identity information, the live broadcast selection information including selectable second live broadcast ends and live broadcast service providers.

3. The method according to claim 1, further comprising:
receiving a connection selection result from the first live broadcast end, the connection selection result including one or more designated second live broadcast ends; and
sending a connection request to the one or more designated second live broadcast ends according to the connection selection result.

4. The method according to claim 1, wherein processing the original live broadcast data to generate the final live broadcast data comprises:
combining the original live broadcast data according to one or more setting rules to generate the final live broadcast data.

5. The method according to claim 1, further comprising:
establishing a connection relationship between the first live broadcast end and the at least one second live broadcast end according to the confirmation result.

6. The method according to claim 5, further comprising:
receiving a withdrawal request from a second live broadcast end of the at least one second live broadcast end; and
deleting the second live broadcast end of the at least one second live broadcast end from the connection relationship.

7. The method according to claim 5, further comprising:
receiving a device usage request, the device usage request including identity information; and
determining a live broadcast account of a corresponding live broadcast user based on the identity information.

8. The method according to claim 1, wherein the live broadcast collaborative server is connected to multiple live broadcast ends, and is able to be connected to multiple live broadcast service providers.

9. One or more computer readable media storing executable instructions that, when executed by one or more processors of a first live broadcast end, cause the one or more processors to perform acts comprising:
sending platform setting information and connection setting information to a live broadcast collaborative server;
receiving connection confirmation information from the live broadcast collaborative server;
obtaining first original live broadcast data and providing the first original live broadcast data to the live broadcast collaborative server; and
receiving final live broadcast data from the live broadcast collaborative server, wherein the platform setting information includes multiple selectable live service providers, the connection setting connection includes multiple selectable second live broadcast ends, and the final live broadcast data includes at least a portion of the first original live broadcast data.

10. The one or more computer readable media according to claim 9, the acts further comprising:
providing a live broadcast interactive interface, the live broadcast interactive interface including platform settings and connection settings; and
receiving the platform setting information and the connection setting information corresponding to a live broadcast user.

11. The one or more computer readable media according to claim 10, wherein the live broadcast interactive interface further includes a video setting.

12. The one or more computer readable media according to claim 11, the acts further comprising:
receiving video setting information corresponding to the live broadcast user; and
sending the video setting information to the live broadcast collaborative server, wherein the final live broadcast data conforms to the video setting information.

13. The one or more computer readable media according to claim 9, wherein the final live broadcast data is formed by first original live broadcast data and second original live broadcast data of one or more second live broadcast ends.

14. The one or more computer readable media according to claim 13, wherein at least two of the first live broadcast end and the one or more second live broadcast ends belong to different live broadcast service providers.

15. The one or more computer readable media according to claim 13, the acts further comprising:
sending a withdrawal request to the live broadcast collaborative server to end a live broadcast between the first live broadcast end and the one or more second live broadcast ends.

16. An apparatus comprising:
one or more processors; and
memory storing executable instructions that, when executed by the one or more processors of a first live broadcast end, cause the one or more processors to perform acts comprising:
receiving a live broadcast request sent by a first live broadcast end;
providing a list of one or more connectable second live broadcast ends to the first live broadcast end;
receiving a confirmation result from the first live broadcast end or at least one second live broadcast end;
receiving original live broadcast data of the first live broadcast end and the at least one second live broadcast end according to the confirmation result;
processing the original live broadcast data to generate final live broadcast data; and
sending the final live broadcast data to one or more live broadcast service providers.

17. The apparatus according to claim 16, the acts further comprising:
determining identity information of the first live broadcast end; and
providing live broadcast selection information to the first live broadcast end according to the identity information, the live broadcast selection information including selectable second live broadcast ends and live broadcast service providers.

18. The apparatus according to claim 16, the acts further comprising:
receiving a connection selection result of the first live broadcast end, the connection selection result including one or more designated second live broadcast ends; and
sending a connection request to the one or more designated second live broadcast ends according to the connection selection result.

19. The apparatus according to claim 16, wherein processing the original live broadcast data to generate the final live broadcast data comprises:
combining the original live broadcast data according to one or more setting rules to generate the final live broadcast data.

20. The apparatus according to claim 16, the acts further comprising:
establishing a connection relationship between the first live broadcast end and the at least one second live broadcast end according to the confirmation result.
